(19) United States
(12) Patent Application Publication
(10) Pub. No.: US 2026/0319671 A1
(43) Pub. Date: Oct. 15, 2026

(54) MEMORY SYSTEMS AND OPERATION METHODS THEREOF, AND ELECTRONIC DEVICES

(71) Applicant: Yangtze Memory Technologies Co., Ltd., Wuhan (CN)

(72) Inventors: Dongrun Qin, Wuhan (CN); Mo Cheng, Wuhan (CN); Tianyi Wang, Wuhan (CN)

(21) Appl. No.: 19/338,828

(22) Filed: Sep. 24, 2025

(30) Foreign Application Priority Data
Apr. 15, 2025 (CN) 202510473687.9

(51) Int. Cl. G06F 3/06

(52) U.S. Cl. CPC G06F 3/0619; G06F 3/0659; G06F 3/0679

(57) ABSTRACT

The examples of the present disclosure provide a memory system, an operation method thereof and an electronic device. The memory system includes: a memory device, the memory device includes a reclaim group that includes a reclaim unit; and a memory controller coupled to the memory device and configured to: create a plurality of namespaces, wherein a first namespace of the namespaces corresponds to at least one reclaim unit handle, the at least one reclaim unit handle is configured to indicate the reclaim unit in the reclaim group; receive a first heat message, where the first heat message is configured to indicate heat of first data written by the first namespace using one reclaim unit handle.

### CROSS-REFERENCE TO RELATED APPLICATION

This application claims priority to and the benefit of Chinese Patent Application 202510473687.9, filed on Apr. 15, 2025, which is hereby incorporated by reference in its entirety.

### TECHNICAL FIELD

The examples of the present disclosure relate to semiconductor technology, and relate to but are not limited to memory systems and operation methods thereof and electronic devices.

### BACKGROUND

With the rapid development of data storage technology, more and more data storage systems appear in the electronic devices used by people, such as solid state drives (SSDs), etc. SSD has been widely used in the fields of military, automotive, industrial, medical, and aviation due to their characteristics of fast read and write speeds, vibration resistance, low power consumption, no noise, low heat and light weight, etc.

### BRIEF DESCRIPTION OF THE DRAWINGS

In the accompanying drawings, like reference numerals may describe like components in different figures. Like reference numerals with different letter suffixes may represent different examples of like components. The accompanying drawings generally illustrate various examples discussed herein by way of example but not limitation.

FIG. 1 is a first schematic diagram of an example system with a memory system according to an example of the present disclosure.

FIG. 2 is a schematic diagram of an example memory card with a memory system according to an example of the present disclosure.

FIG. 3 is a schematic diagram of an example solid-state drive with a memory system according to an example of the present disclosure.

FIG. 4 is a schematic diagram of an example memory device comprising a peripheral circuit according to an example of the present disclosure.

FIG. 5 is a schematic diagram of an example memory comprising a memory array and a peripheral circuit according to an example of the present disclosure.

FIG. 6 is a second schematic diagram of an example system with a memory system according to an example of the present disclosure.

FIG. 7 is a first schematic diagram of a memory system supporting a flexible data placement function according to an example of the present disclosure.

FIG. 8 is a first schematic diagram of a configuration of a reclaim group provided by an example of the present disclosure.

FIG. 9 is a second schematic diagram of a configuration of a reclaim group provided by an example of the present disclosure.

FIG. 10 is a first schematic diagram of a garbage collection provided by an example of the present disclosure.

FIG. 11 is a second schematic diagram of a garbage collection provided by an example of the present disclosure.

FIG. 12 is a first schematic diagram of a configuration scheme of virtual machines and reclaim unit handles provided by an example of the present disclosure.

FIG. 13 is a schematic diagram of a memory system provided by an example of the present disclosure.

FIG. 14 is a schematic diagram of reclaim unit handles, usage information, and second heat messages in a log page provided by an example of the present disclosure.

FIG. 15 is a schematic diagram of a configuration information format provided by an example of the present disclosure.

FIG. 16 is a schematic diagram of an electronic device provided by an example of the present disclosure.

FIG. 17 is a flow chart of an operation method of a memory system provided by an example of the present disclosure.

FIG. 18 is a second schematic diagram of a configuration scheme of virtual machines and reclaim unit handles provided by an example of the present disclosure.

### DETAILED DESCRIPTION

Examples of the present disclosure will be described in more detail below with reference to the accompanying drawings. Although examples of the present disclosure are shown in the drawings, it should be understood that the present disclosure may be implemented in various ways and should not be limited to the DETAILED DESCRIPTION set forth herein. Rather, these examples are provided so that the present disclosure can be more thoroughly understood and the scope of the present disclosure can be fully conveyed to those skilled in the art.

In the following description, numerous specific details are given in order to provide a more thorough understanding of the present disclosure. It will be apparent, however, to one skilled in the art that the present disclosure may be practiced without one or more of these details. In other examples, some technical features well-known in the art are not described to avoid confusion with the present disclosure; that is, not all features of the actual example are described here, and well-known functions and structures are not described in detail.

In the accompanying drawings, the same reference numerals represent the same elements throughout.

It should be understood that, spatial relationship terms such as “under”, “below”, “lower”, “beneath” , “on”, “upper” and so on, can be used here for ease of description to describe the relationship between one element or feature and other elements or features shown in the figures. It will be understood that the spatially relationship terms also intend to comprise different orientations of the device in use and operation in addition to the orientation illustrated in the figures. For example, if the device in the figures is turned over, the element or feature described as “below” or “beneath” or “under” other elements or features would then be oriented as “on” the other elements or features. Thus, the example terms “below” and “under” can comprise may include both upper and lower orientations. The device may be otherwise oriented (rotated 90 degrees or at other orientations) and the spatial description terms used herein may be interpreted accordingly.

A term used herein is for the purpose of describing particular examples only and is not to be taken as a limitation of the present disclosure. As used herein, “a”, “an” and “said/the” in singular forms are also intended to include the plural forms, unless the context clearly dictates otherwise. It should also be understood that terms “comprise” and/or “include”, when used in this specification, determine the presence of the stated features, integers, steps, operations, elements or components, but do not exclude presence or addition of one or more other features, integers, steps, operations, elements, components or groups. As used herein, the term “and/or” includes any and all combinations of the associated listed items.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

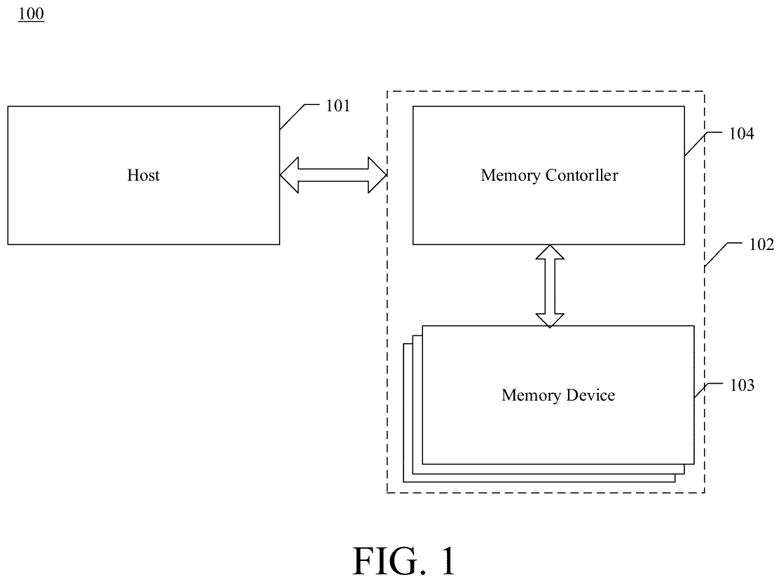

FIG. 1 is a schematic diagram of an example system with a memory system provided by an example of the present disclosure. In an example of the present disclosure, the system 100 may comprise a mobile phone, a desktop computer, a laptop, a tablet, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the system 100 may comprise a host 101 and a memory system 102, where the memory system 102 may comprise one or more memory devices 103 and a memory controller 104. The host 101 may comprise a processor of an electronic device, such as a central processing unit (CPU), or a system on a chip (SoC), such as an application processor (AP). The host 101 may be configured to send data to the memory system 102 or receive data from the memory system 102.

In some implementations, the memory controller 104 is coupled to the memory device 103 and the host 101, and is configured to control the memory device 103. The memory controller 104 can manage data stored in the memory device 103 and communicate with the host 101. In some implementations, the memory controller 104 is designed to operate in a low duty cycle environment, such as in a secure digital (SD) card, a compact flash card (CFC), a universal serial bus (USB) flash drive, or in other media used in electronic devices such as a personal computer, a digital camera, a mobile phone, etc. In some other implementations, the memory controller 104 is designed to operate in a high duty cycle environment, such as a solid state drive or an embedded multimedia card (eMMC).

In some examples, the memory controller 104 and one or more memory devices 103 can be integrated into various types of memory devices, that is, the memory system 102 can be implemented and packaged into different types of terminal electronic products.

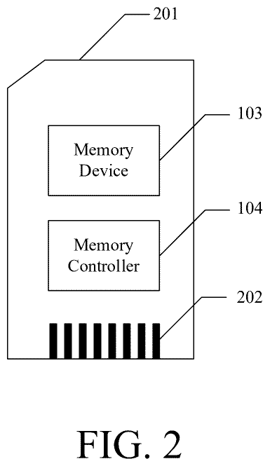

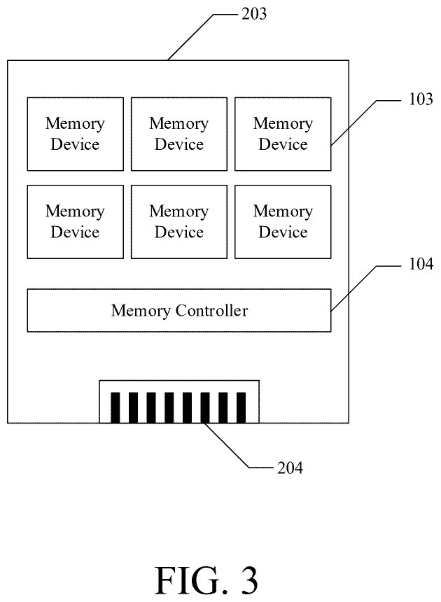

In an example as shown in FIG. 2, the memory controller 104 and a single memory device 103 can be integrated into a memory card 201. The memory card 201 may comprise one of a compact flash card, a smart media card (SMC), a memory stick (MS), a multimedia card (MMC), such as reduced size MMC (RS-MMC), MMCmicro, eMMC, etc., a secure digital card, such as a Mini SD card, a Micro SD card, an SD high capacity (SDHC) card, etc., or a general flash card. The memory card 201 may also comprise a memory card connector 202 that couples the memory card 201 with a host-side device (e.g., the host 101 in FIG. 1). In another example as shown in FIG. 3, the memory controller 104 and a plurality of memory devices 103 may be integrated into an SSD 203. The SSD 203 may also comprise an SSD connector 204 that couples the SSD 203 with a host-side device (e.g., the host 101 in FIG. 1). In some implementations, the storage capacity or operating speed of the SSD 203 is greater than that of the memory card 201.

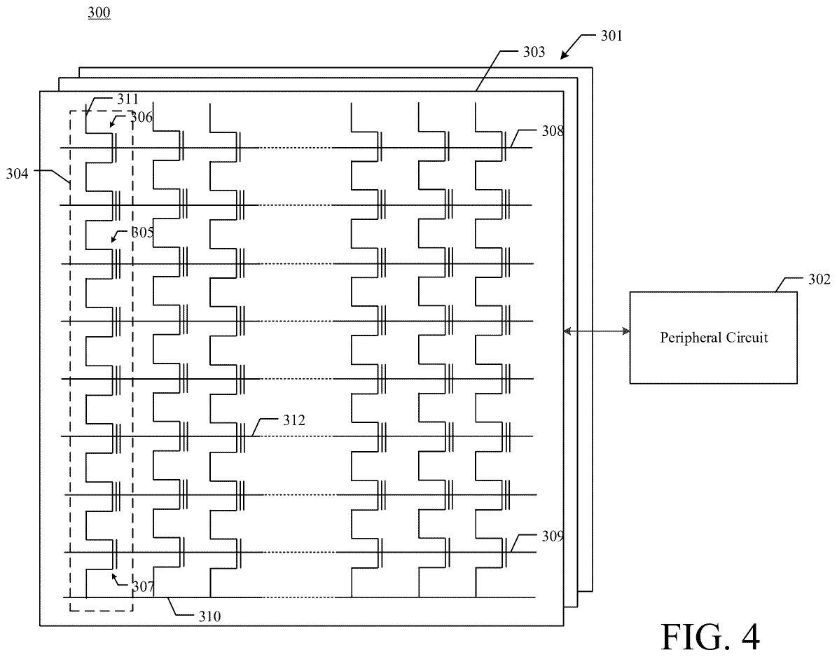

FIG. 4 is a circuit schematic diagram of an example memory device 300 comprising a peripheral circuit provided by an example of the present disclosure. The memory device 300 may be an example of the memory device 103 in FIG. 1. The memory device 300 may comprise a memory array 301 and a peripheral circuit 302 coupled to the memory array 301. The memory array 301 is taken as an example of a three-dimensional NAND type memory array for illustration, where a memory cell 305 is a NAND memory cell, and the memory cells 305 are provided in the form of an array of memory cell strings 304, each memory cell string 304 extending vertically above a substrate (not shown). In some implementations, each memory cell string 304 comprises a plurality of memory cells 305 coupled in series and stacked vertically. Each memory cell 305 may hold a continuous analog value, such as a voltage or charge, which depends on the number of electrons trapped in the region of the memory cell 305. Each memory cell 305 may be a floating gate type memory cell comprising a floating gate transistor, or a charge trap type memory cell comprising a charge trap transistor.

In some implementations, each memory cell 305 comprises a single level cell (SLC) which has two possible memory states and thus can store one bit of data. For example, the first memory state “0” can correspond to a first voltage range, and the second memory state “1” can correspond to a second voltage range. In some implementations, each memory cell 305 comprises a multi-level cell capable of storing more than a single bit of data in four or more memory states, for example, a multi-level cell (MLC) storing two bits per cell, a triple level cell (TLC) storing three bits per cell, or a quad-level cell (QLC) storing four bits per cell.

As shown in FIG. 4, each memory cell string 304 can comprise a bottom select transistor (BST) 307 at its source end and a top select transistor (TST) 306 at its drain end. The bottom select transistor 307 and the top select transistor 306 can be configured to activate a selected memory cell string 304 during read and program operations. In some examples, the sources of the memory cell strings 304 in the same memory block 303 may be coupled via a common source line (Common Source Line, CSL) 310. In other words, all memory cell strings 304 in the same memory block 303 have an array common source (ACS). According to some implementations, the top selection transistor 306 of each memory cell string 304 is coupled to a corresponding bit line (BL) 311 from which data can be read or written via an output bus (not shown). In some implementations, each memory cell string 304 is configured to be selected or deselected by at least one of applying a select voltage (e.g., a voltage higher than a threshold voltage of the top select transistor 306) or a deselect voltage (e.g., 0V) to a top select gate (TSG) of the corresponding top select transistor 306 through one or more top select lines (TSL) 308 or applying a select voltage (e.g., a voltage higher than a threshold voltage of the bottom select transistor 307) or a deselect voltage (e.g., 0V) to a bottom select gate (BSG) of the corresponding bottom select transistor 307 through one or more bottom select lines (BSL) 309.

As shown in FIG. 4, the memory cell strings 304 can be organized into a plurality of memory blocks 303, each of which can have a common source line 310. In some implementations, each memory block 303 is a basic data unit for an erase operation, e.g., all memory cells 305 on a same memory block 303 are erased at the same time. To erase the memory cells 305 in the selected memory block, a common source line 310 coupled to the selected memory block and unselected memory blocks in the same plane as the selected memory block may be biased with an erase voltage. It should be understood that in some examples, the erase operation may be performed at a half-memory block level, at a quarter-memory block level, or at a level having any suitable number of memory blocks or any suitable fractions of a memory block. The memory cells 305 of adjacent memory cell strings 304 may be coupled via word lines 312 that select which row of memory cells 305 is affected by read or program operations.

In some examples, the peripheral circuit 302 may comprise any suitable analog, digital, and mixed-signal circuits for implementing the operations on the memory array 301 by applying and sensing at least one of voltage signals or current signals to and from each target memory cell 305 through bit lines 311, word lines 312, common source lines 310, bottom select lines 309, and top select lines 308. The peripheral circuit 302 may comprise various types of peripheral circuits formed using metal-oxide-semiconductor technology.

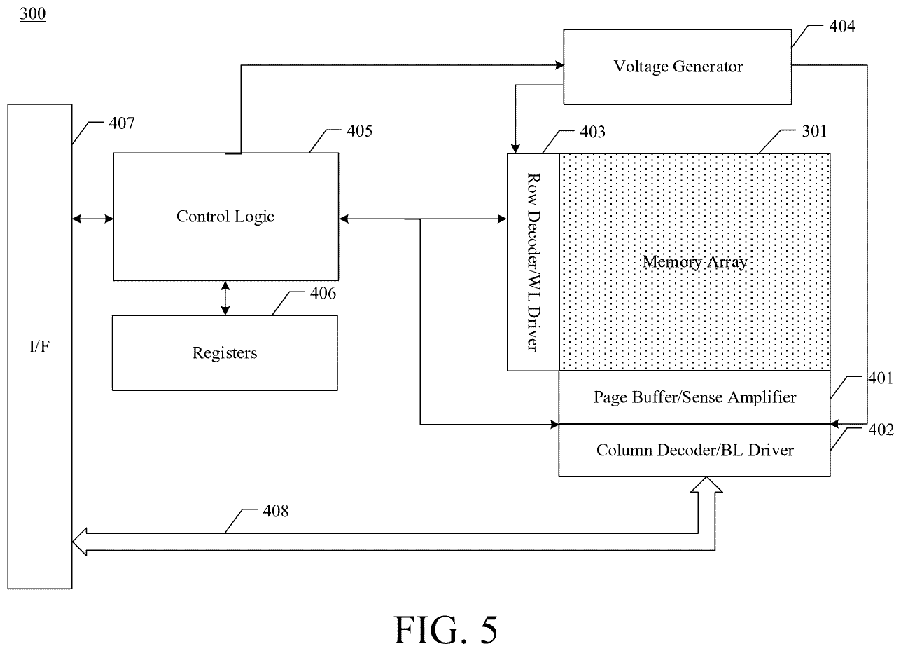

FIG. 5 shows some example peripheral circuits, and the peripheral circuit 302 comprises a page buffer/sense amplifier 401, a column decoder/bit line driver 402, a row decoder/word line driver 403, a voltage generator 404, a control logic 405, a register group 406, a flash memory interface 407, and a data bus 408. It should be understood that in some examples, additional peripheral circuits not shown in FIG. 5 may also be included.

The page buffer/sense amplifier 401 can be configured to read data from the memory array 301 and program (write) data to the memory array 301 according to a control signal from the control logic 405. In one example, the page buffer/sense amplifier 401 can store a page of program data (write data) to be programmed into the memory array 301. In another example, the page buffer/sense amplifier 401 can perform a program verify operation to ensure that data has been correctly programmed into the memory cells coupled to the selected word line. In yet another example, the page buffer/sense amplifier 401 can also sense the low power signals from the bit line that represent data bits stored in the memory cells and amplify the small voltage swing to recognizable logic levels in a read operation. The column decoder/bit line driver 402 can be configured to be controlled by the control logic 405 and select one or more memory cell strings by applying bit line voltages generated from the voltage generator 404.

The row decoder/word line driver 403 can be configured to be controlled by the control logic 405 and select/deselect a memory block of the memory array 301 and select/deselect a word line of memory blocks. The row decoder/word line driver 403 can be further configured to drive a word line using a word line voltage generated from the voltage generator 404. In some implementations, the row decoder/word line driver 403 can also select/deselect and drive a bottom select line and a top select line as well. As described below in detail, the row decoder/word line driver 403 is configured to perform a program operation on a memory cell coupled to the selected word line(s). The voltage generator 404 can be configured to be controlled by the control logic 405 and generate the word line voltages (e.g., read voltages, program voltages, pass voltages, local voltages, verification voltages, etc.), bit line voltages, and source line voltages to be supplied to the memory array 301.

The control logic 405 may be coupled to each peripheral circuit described above and configured to control the operation of each peripheral circuit. The register group 406 can be coupled to the control logic 405 and include status registers, command registers, and address registers for storing status information, command operation codes (OP codes), and command addresses for controlling the operations of each peripheral circuit. The flash memory interface 407 may be coupled to the control logic 405 and act as a control buffer, to buffer and relay control commands received from a host-side device (not shown) to the control logic 405, and to buffer and relay status information received from the control logic 405 to the memory controller. The flash memory interface 407 may further be coupled to the column decoder/bit line driver 402 via the data bus 408 and act as a data input/output (I/O) interface and data buffer to buffer and relay data to or from the memory array 301.

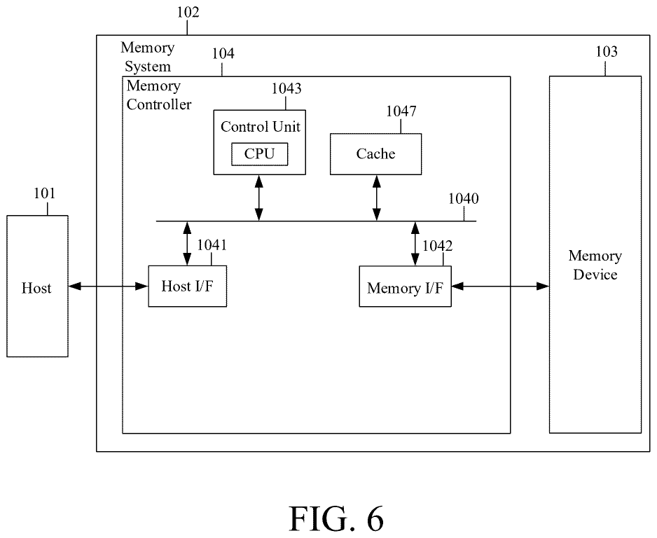

FIG. 6 is a schematic diagram of a system comprising a host and a memory system provided by an example of the present disclosure. As shown in FIG. 6, the memory system 102 is connected to the host 101, where the memory system 102 may comprise a memory controller 104 and a memory device 103. The memory controller 104 may be configured to control operations such as reading, erasing, and programming of the memory device 103; it may also be configured to manage various functions regarding data stored or to be stored in the memory device 103, including but not limited to bad block management, garbage collection, logical to physical address conversion, wear leveling, etc.; it may also be configured to process error correction codes (ECC) regarding data read from or written to the memory device 103. In addition, the memory controller 104 may also perform any other suitable functions, such as formatting the memory device 103, or communicating with an external device (e.g., the host 101 in FIG. 1) according to a specific communication protocol. The memory controller 104 and the memory device 103 may be coupled in any suitable manner. The memory controller 104 may include a host interface (I/F) 1041, a memory interface (I/F) 1042, a control unit 1043, a cache 1047, and a bus 1040. The host interface 1041 is a connection interface between the host 101 and the memory controller 104. The host interface 1041 allows the host 101 and the memory controller 104 to communicate according to a specific protocol, send read and write requests, and perform other operations. The memory interface 1042 is a connection interface between the memory controller 104 and the memory device 103. The memory interface 1042 is configured to implement data transmission between the memory controller 104 and the memory device 103. The control unit 1043 is configured to control the memory system 102 as a whole.

It can be understood that some flash memories cannot be overwritten. Therefore, as user data is continuously written, garbage (invalid data) will be generated in the flash memory space. Garbage collection is to move valid data on one or several memory blocks out and write it to new free memory blocks. When the valid data on these memory blocks is moved out, the memory blocks are erased so that they are available for writing new data.

In some examples, the control unit 1043 may comprise one or more units with logical operation capabilities, such as at least one of a central processing unit (CPU) or a microcontroller unit (MCU).

In some examples, the cache 1047 is configured to cache data, and may be a volatile memory device with a relatively fast read and write speed, such as at least one of a static random access memory (SRAM) or a dynamic random access memory (DRAM).

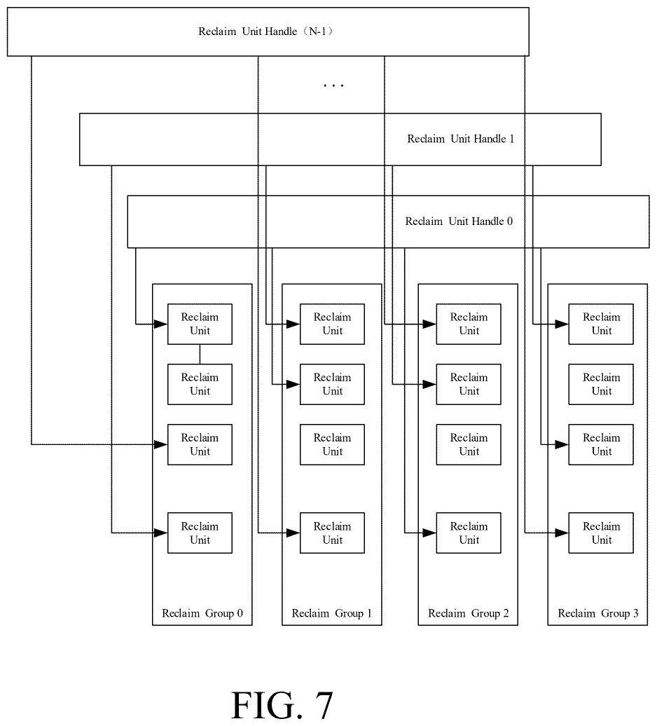

FIG. 7 is a schematic diagram of a memory system supporting a flexible data placement (FDP) function. The memory system includes four reclaim groups (RG) identified as reclaim group 0 to reclaim group 3. Each reclaim group may include one or more reclaim unit (RU). It can be understood that the number of above reclaim groups is only an example. The memory system may receive an I/O command from a host through a communication interface. The I/O command is described as a write command below for illustration. The write command may include reclaim group information and information of a placement handle associated with a reclaim unit handle, which may enable the host to specify a reclaim group and a reclaim unit handle (RUH). When the reclaim group information and the information of reclaim unit handle are determined, the reclaim unit pointed to is also determined, and the reclaim unit may be configured to store data to be written. A memory system supporting a flexible data placement function has many advantages because it exposes the underlying logic of the device to the host, such as being able to achieve a write amplification close to 1 and being backward compatible with traditional applications (APP).

The memory system is taken as an example of SSD below for illustration. It should be understood that the memory system of the examples of the present disclosure is not limited thereto.

In some examples, a memory device includes a plurality of dies each including a plurality of memory blocks; a memory controller is configured to: divide the plurality of dies into at least one reclaim group each including at least one die; and a reclaim unit includes memory blocks that are located at the same position of the at least one die in the reclaim group.

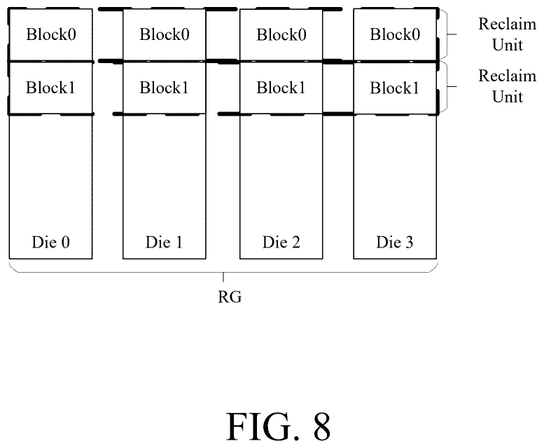

In some examples, as shown in FIG. 8, the configuration of the reclaim group may be that: the entire SSD is considered as one reclaim group (RG), the SSD includes a plurality of dies and all the dies are divided into one reclaim group. Each die includes a plurality of memory blocks. The plurality of memory blocks are numbered in sequence, for example, starting from 0. In different dies, memory blocks with the same number may constitute one super memory block, and one super memory block constitutes a reclaim unit. For example, Block0 of die 0, Block0 of die 1, Block0 of die 2, and Block0 of die 3 constitute one reclaim unit.

Here, the memory blocks at the same position of the die can be understood as the memory blocks with the same number of the dies.

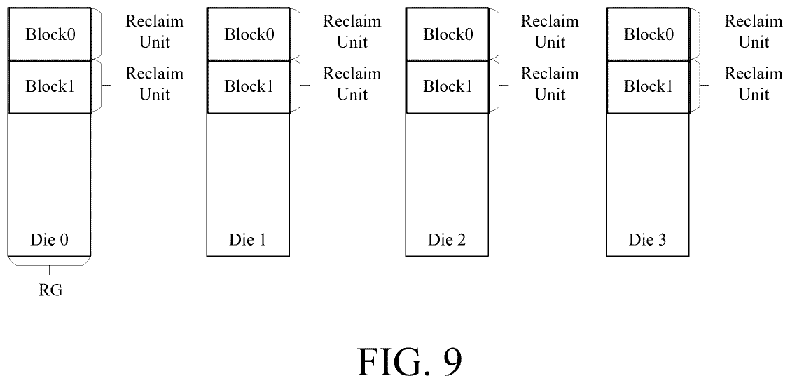

In some examples, as shown in FIG. 9, the configuration of the reclaim group may be that one or more dies in the SSD are considered as one RG. It should be noted that in this solution, a plurality of dies are not equal to all dies in the SSD. For example, if the total number of dies in the SSD is 4, one or two dies can be considered as one RG. As shown in FIG. 9, if one die is considered as one RG, then one memory block in one die can be used as one reclaim unit. Block0 of die 0 constitutes one reclaim unit, and Block0 of die 1 also constitutes one reclaim unit. In some other examples, two dies are considered as one RG, and the memory blocks with the same number in the two dies can be considered as one reclaim unit. For example, die 0 and die 1 are considered as one RG, and Block0 of die 0 and Block0 of die 1 can constitute one reclaim unit. Die 2 and die 3 are considered as one RG, and Block0 of die 2 and Block0 of die 3 can also constitute one reclaim unit.

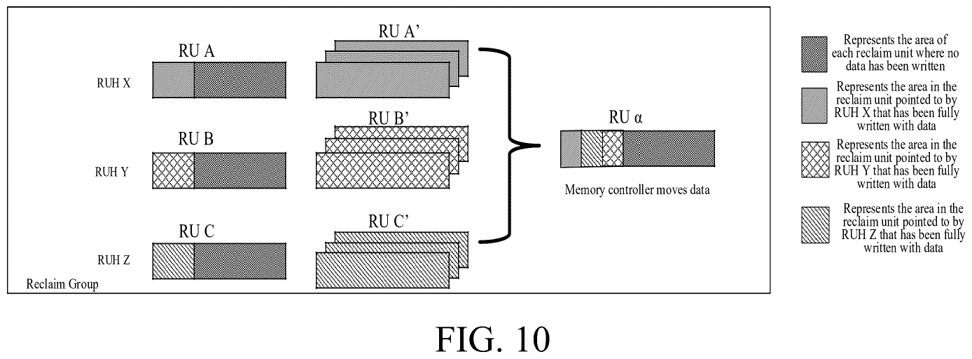

In some examples, the type of a reclaim unit handle includes an initially isolated type reclaim unit handle. As shown in FIG. 10, the reclaim unit handle RUH X currently points to the reclaim unit RU A, and the reclaim unit RU A′ is the reclaim unit to which data has been written through the reclaim unit handle RUH X; and the reclaim unit RU A′ currently still stores the data written through the reclaim unit handle RUH X, and the reclaim unit RU A′ has been fully written with data; and one part of the reclaim unit RU A has been written with data, and the other part of the reclaim unit RU A has not been written with data. The reclaim unit handle RUH Y currently points to the reclaim unit RU B, and the reclaim unit RU B′ is the reclaim unit to which data has been written through the reclaim unit handle RUH Y; the reclaim unit RU B′ currently still stores the data written through the reclaim unit handle RUH Y, and the reclaim unit RU B′ has been fully written with data; and one part of the reclaim unit RU B has been written with data, and the other part of the reclaim unit RU B has not been written with data. The reclaim unit handle RUH Z currently points to the reclaim unit RU C, and the reclaim unit RU C′ is the reclaim unit to which data has been written through the reclaim unit handle RUH Z; and the reclaim unit RU C′ currently still stores the data written through the reclaim unit handle RUH Z, and the reclaim unit RU C′ has been fully written with data; and one part of the reclaim unit RU C has been written with data, and the other part of the reclaim unit RU C has not been written with data.

As shown in FIG. 10, when a garbage collection operation is performed on the data in the reclaim units pointed to by RUH X (including the reclaim unit RU A currently pointed to by the reclaim unit handle and the reclaim unit RU A′ storing valid data that has been written through the reclaim unit handle), the data in the reclaim units RU B and RU B′ pointed to by RUH Y, and the data in the reclaim units RU C and RU C′ pointed to by RUH Z, the data written through RUH X, RUH Y, and RUH Z will be reclaimed to the same reclaim unit in RU α. In this example, data of different types, different heats, and different life cycles can be written through different reclaim unit handles during a data writing phase, and good physical isolation of data can be achieved during the data writing phase, however during the garbage collection operation, data of different types, different heats, and different life cycles will be moved to be together, such that the physical isolation of data is good enough.

In the example of the present disclosure, data of different types may be understood as data of different applications.

In the example of the present disclosure, data can be divided into three types according to their degree of heat, including hot, warm, and cold. In some examples, the heat of data can be related to the frequency of use of data. In some other examples, the heat of data can be defined based on the data type. For example, a data block of one catalog can be fixed as hot data. In other examples, the heat of data can also be defined based on other data characteristics.

In the example of the present disclosure, the life cycle of data can be understood as the time from when the data is written to when it is erased.

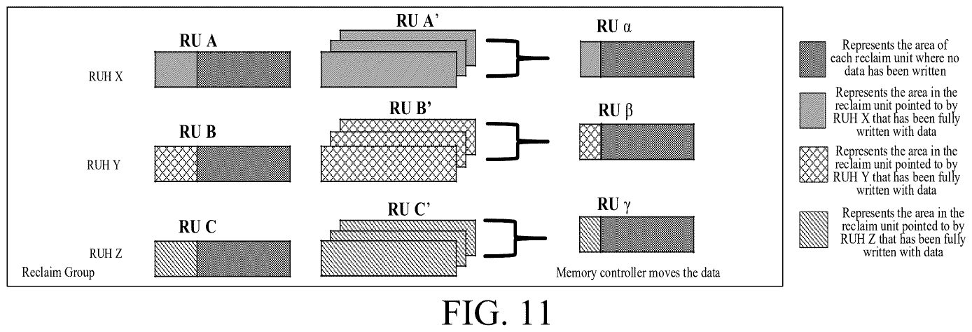

In some examples, the type of a reclaim unit handle includes a persistently isolated type reclaim unit handle. As shown in FIG. 11, when a garbage collection operation is performed on the data in the reclaim units pointed to by RUH X (including the reclaim unit RU A currently pointed to by the reclaim unit handle and the reclaim unit RU A′ storing valid data that has been written through the reclaim unit handle), the data in the reclaim units RU B and RU B′ pointed to by RUH Y, and the data in the reclaim units RU C and RU C′ pointed to by RUH Z, the data written by RUH X will be reclaimed to the reclaim unit RU α, the data written by RUH Y will be reclaimed to the reclaim unit RU β, and the data written by RUH Z will be reclaimed to the reclaim unit RU γ. When a garbage collection operation is performed on data in a reclaim unit pointed to by a persistently isolated type reclaim unit handle, a reclaim unit that has been used as the garbage collection destination by the reclaim unit handle will be used first, or a new reclaim unit will be applied for, and data in reclaim units pointed to by different reclaim unit handles will be reclaimed to different reclaim units respectively. This example can keep data of the same type always at the same reclaim unit handle, whether in the data writing stage or after the subsequent garbage collection operation, with good physical isolation, and only valid data of the same type needs to be moved after a plurality of garbage collection operations. However, when performing garbage collection operations, the solution provided by this example requires the firmware to open more super memory blocks or more memory blocks at the same time, which makes firmware implementation difficult.

In some examples, using the FDP function of a memory system (e.g., an SSD) may include the following process: first operation, the host queries whether the memory controller of the memory system supports the FDP function, and if so, proceeds to the subsequent operations; second operation, all namespaces in the current endurance group are deleted; third operation, the host uses the get log page command to query the configuration information of the FDP function; fourth operation, the host enables the FDP function through the set feature command; fifth operation, the host uses the get feature command to obtain the FDP event feature; sixth operation, each reclaim unit handle is set and an event is specified; seventh operation, the host sends an Identifier command to specify the data structure and logical block address format (LBA format) of the current namespace; eighth operation, the host sends a namespace management command to create a namespace, particularly including a namespace creation operation, determining a data format, and issuing a placement handle list; ninth operation, the host sends a read command and a write command, where the write command carries indication information (such as a placement handle and a reclaim group identifier) to indicate the reclaim unit handle and reclaim group corresponding to the write data. It should be noted that the order of the above operations can be adjusted according to actual demand, and other additional operations can be performed before or after any operation.

In some examples, a plurality of log pages are stored in the memory system, and the log pages can be configured to record various information related to the flexible data placement function. The log pages can be stored in the memory device or in the cache of the memory controller. For example, the log page can record the usage information of individual reclaim unit handles, such as whether the reclaim unit handle is used by the host. However, when the log page only records the usage information of individual reclaim unit handles, the host cannot clearly know the data heat corresponding to individual reclaim unit handles.

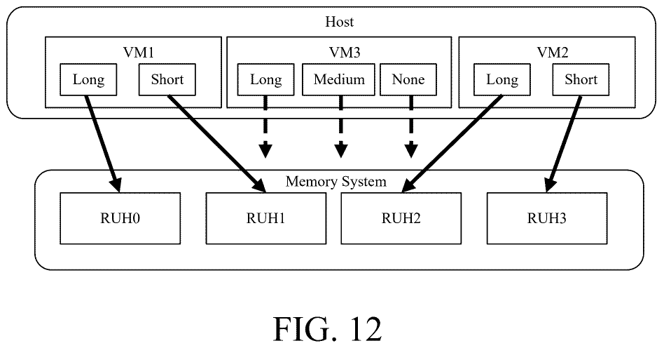

In some examples, as shown in FIG. 12, a host may deploy a plurality of virtual machines (VMs), and the plurality of virtual machines run on the host. Here, three virtual machines VM1, VM2, and VM3 are used as examples for illustration. Each virtual machine can access and use at least one namespace (NS) of the memory system, and the write data corresponding to each virtual machine has different data heat, for example, there are four data heats of “None”, “Short”, “Medium”, and “Long”. In some examples, the write data with the heat of “Long” and “Short” in virtual machine VM1 uses the reclaim unit handles RUH0 and RUH1 respectively; then, the write data with the heat of “Long” and “Short” in virtual machine VM2 uses the reclaim unit handles RUH2 and RUH3 respectively, and at this time all of the reclaim unit handles RUH0 to RUH3 have been used; in this way, virtual machine VM3 has to share at least one reclaim unit handle with at least one of virtual machine VM1 or virtual machine VM2, and virtual machine VM3 does not know the data heat corresponding to each of the reclaim unit handles RUH0 to RUH3. Random use of reclaim unit handles will cause confusion of data with different heats, resulting in additional write amplification during garbage collection. In addition, when the reclaim unit handle resources are limited, data with similar heats in virtual machines VM1 and VM2 should be combined to use the same reclaim unit handle to release the reclaim unit handle resources for use by data with other heats in virtual machine VM3. In other words, the host side cannot obtain the data heat corresponding to the reclaim unit handle currently in use, so the user cannot select a suitable reclaim unit handle.

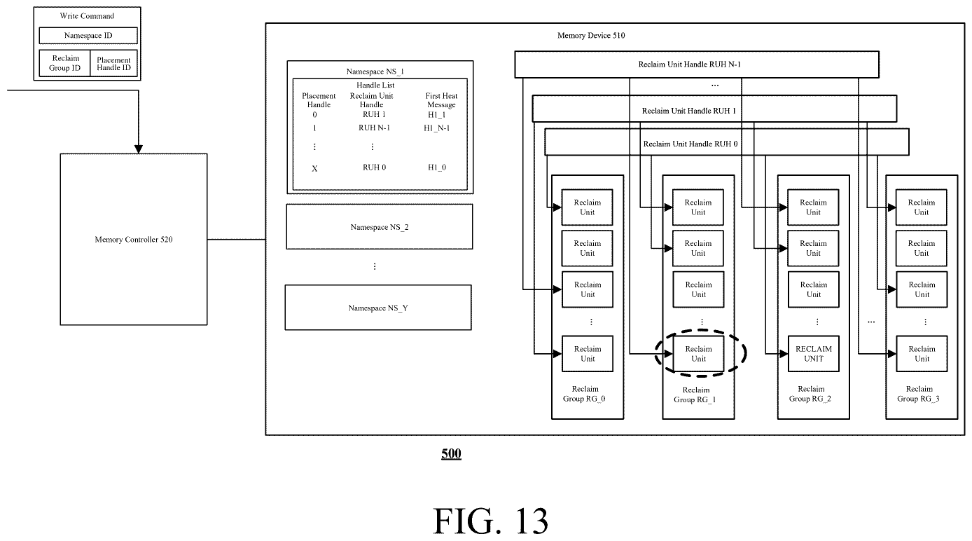

As shown in FIG. 13, an example of the present disclosure provides a memory system 500, which includes: at least one memory device 510, the memory device 510 includes at least one reclaim group each including at least one reclaim unit; a memory controller 520 coupled to the memory device 510 and configured to: create a plurality of namespaces; where each namespace corresponds to at least one reclaim unit handle, a reclaim unit handle is configured to indicate one corresponding reclaim unit in each reclaim group; receive a plurality of first heat messages; each first heat message is configured to indicate heat of data written by one of the created namespaces using one reclaim unit handle.

In the example of the present disclosure, the memory system 500 includes at least one memory device 510 and a memory controller 520 coupled to the memory device 510. Here, the memory system 500 is taken as an example of SSD supporting the FDP function for illustration. It should be understood that the memory system 500 of the examples of the present disclosure is not limited thereto.

The memory device 510 can be identified as a plurality of reclaim groups each including one or more reclaim units. The memory controller 520 can receive a namespace creation request command sent by an external device (such as a host) to create a namespace. In some examples, each namespace creation request command can be configured to create a namespace; in some other examples, each namespace creation request command can be configured to create a plurality of namespaces. For example, referring to FIG. 13, the memory controller 520 creates Y namespaces including namespace NS_1 to namespace NS_Y, where Y is a positive integer.

In some examples, the memory controller 520 is configured to: receive a handle list corresponding to the created namespace; where the handle list comprises a mapping relationship between a plurality of placement handles and a plurality of reclaim unit handles, and the first heat message corresponding to each of the reclaim unit handles; and the placement handle is configured to indicate a corresponding reclaim unit handle in a write command.

The external device may specify at least one reclaim unit handle for each created namespace. For example, when the host sends a namespace creation request command, it will issue a placement handle list corresponding to the namespace, referred to as a handle list herein. The placement handle list may include a plurality of placement handles and a plurality of reclaim unit handle IDs corresponding to the plurality of placement handles. In this way, the external device may send a write command including a namespace ID, a reclaim group ID, and placement handle information, so as to write the write data to the corresponding reclaim unit in the memory device 510. For example, if the namespace ID indicated by the write command is “NS_1”, the reclaim group ID is “RG_1”, and the placement handle is “1”, the write data will be written to the reclaim unit indicated by the reclaim unit handle RUH N-1 in the reclaim group RG_1 (as shown by the dotted circle in FIG. 13).

When sending a namespace creation request command, the external device will also issue the first heat message corresponding to each reclaim unit handle used by the created namespace, and the first heat message is configured to indicate the heat of the data written by one created namespace using one reclaim unit handle. Referring to FIG. 13, each created namespace corresponds to one handle list which includes one or more reclaim unit handles used by the namespace, as well as the first heat messages corresponding one-to-one with the reclaim unit handles. It should be noted that the external device can also issue the first heat messages to the memory system 500 in other ways, and is not limited to issue the first heat message through a handle list.

In this way, the memory controller 520, in response to a namespace creation request command sent by the external device, creates a namespace and receives a plurality of first heat messages corresponding to the created namespace. That is, the memory controller 520 can receive a plurality of first heat messages and record the heat of the data written by the created namespace using individual reclaim unit handles. For example, the memory controller 520 can separately record the heat message of all written data corresponding to each reclaim unit handle (that is, the data written by one or more created namespaces using the reclaim unit handle). This enables the external device to reasonably configure the reclaim unit handles used by the new namespace when creating a new namespace, for example, the heat of the data to be written corresponding to the new namespace is similar to or the same as the heat of the written data corresponding to the reclaim unit handle to be used by the new namespace, thereby reducing the additional write amplification caused by using the same reclaim unit handle for data with large differences in heat.

In some examples, the memory controller 520 is further configured to: update a second heat message of a respective reclaim unit handle in a log page based on the first heat message; where the log page comprises second heat messages corresponding to the individual reclaim unit handles; and the second heat message is configured to indicate heat of data written by all namespaces that use a same reclaim unit handle.

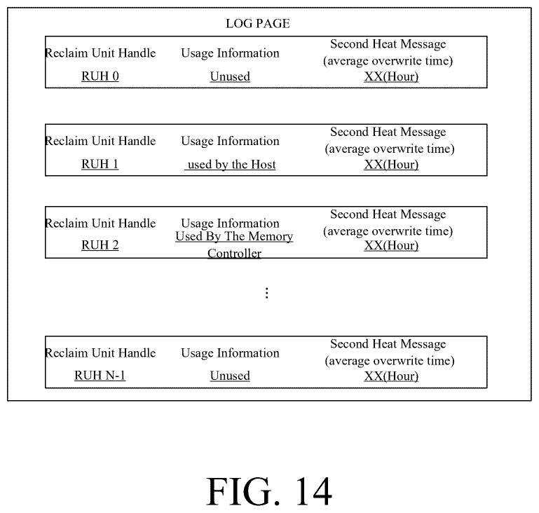

In an example of the present disclosure, a plurality of log pages may be stored in the memory system 500, and the log page may be configured to record various configuration information related to the flexible data placement function. The log page may be stored in either the memory device 510 or the cache of the memory controller 520. For example, referring to FIG. 14, the log page may record the second heat messages of individual reclaim unit handles, and each second heat message is configured to indicate the heat of the data that has been written by all namespaces that use one reclaim unit handle corresponding to the second heat message. It should be noted that any FDP configuration information (such as usage information, etc.) corresponding to individual reclaim unit handles may also be recorded in the log page. The second heat message may be the average heat value of the data that has been written by all namespaces that use the same reclaim unit handle, the maximum heat value and the minimum heat value of the data that has been written by all namespaces that use the same reclaim unit handle, or the median of the heat value of the data that has been written by all namespaces that use the same reclaim unit handle, etc., and the form of the second heat message is not overly restricted herein.

In this way, the log page separately records the second heat message corresponding to each reclaim unit handle. This enables the external device to reasonably configure the reclaim unit handle used by a new namespace when creating the new namespace, for example, the heat of the data to be written corresponding to the new namespace is similar to or the same as the second heat message corresponding to the reclaim unit handle to be used by the new namespace, thereby reducing the additional write amplification caused by using the same reclaim unit handle for data with large differences in heat.

In some examples, the second heat message comprises an average heat value of data written by all namespaces that use the same reclaim unit handle; the memory controller is further configured to: in response to a write command, write data to be written into a reclaim unit indicated by a target reclaim unit handle corresponding to the write command; where a difference value between a heat value of the data to be written and an average heat value of data written by all namespaces that use the target reclaim unit handle is less than a first preset value.

In an example of the present disclosure, the second heat message may include the average heat value of a plurality pieces of data written by all namespaces that use the same reclaim unit handle. For example, the average overwrite time may be configured to represent the second heat message, and the unit of the average overwrite time can be hours. In some examples, when the average overwrite time is configured to represent the average heat value of a plurality pieces of data that have been written, its default value may be 0xffff to indicate that the external device has not specified the heat message of the reclaim unit handle.

An external device (such as a host) can send a write command to the memory controller 520 of the memory system 500, and the write command carries a namespace ID, a reclaim group ID, and placement handle information, thereby indicating the namespace, reclaim group, and reclaim unit handle corresponding to the data to be written. It can be understood that before sending the write command, the external device can obtain the second heat messages corresponding to individual reclaim unit handles in the log page from the memory system 500, so as to determine the reclaim unit handle that matches the heat of the data to be written according to the heat of the data to be written. For example, the external device can determine the reclaim unit handle whose difference value between the average heat value and the heat value of the data to be written is less than the first preset value as the target reclaim unit handle corresponding to the data to be written, where the first preset value can be adjusted according to the actual data heat degree classification requirements. Finally, in response to the write command, the memory controller 520 writes the data to be written into the respective reclaim unit through the target reclaim unit handle corresponding to the write command.

That is, the difference value between the heat value of the data to be written and the average heat value of the data written by all namespaces corresponding to the target reclaim unit handle determined by the external device is less than the first preset value. This enables the external device to reasonably configure the reclaim unit handle used by a new namespace when creating the new namespace, thereby reducing the additional write amplification caused by using the same reclaim unit handle for data with large heat difference.

In some examples, the second heat message comprises a maximum heat value and a minimum heat value of data written by all namespaces that use the same reclaim unit handle; the memory controller is further configured to: in response to a write command, write data to be written into a reclaim unit indicated by a target reclaim unit handle corresponding to the write command; where a heat value of the data to be written is less than or equal to a maximum heat value of data written by all namespaces that use the target reclaim unit handle, and the heat value of the data to be written is greater than or equal to a minimum heat value of the data written by all namespaces that use the target reclaim unit handle.

In an example of the present disclosure, the second heat message may include the maximum heat value and the minimum heat value of a plurality pieces of data written by all namespaces that use the same reclaim unit handle. For example, the second heat message may be characterized by an average overwrite time. In some examples, when the average overwrite time is configured to represent the maximum heat value and the minimum heat value of a plurality pieces of data that have been written, the maximum default value may be 0xffff, and the minimum default value may be 0x0.

An external device (such as a host) can send a write command to the memory controller 520 of the memory system 500, and the write command carries a namespace ID, a reclaim group ID, and placement handle information, thereby indicating the namespace, reclaim group, and reclaim unit handle corresponding to the data to be written. It can be understood that before sending the write command, the external device can obtain the second heat messages corresponding to individual reclaim unit handles in the log page from the memory system 500, so as to determine the reclaim unit handle that matches the heat of the data to be written according to the heat of the data to be written. For example, the external device can select a suitable target reclaim unit handle so that the heat value of the data to be written is within the heat value range between the maximum heat value and the minimum heat value corresponding to the target reclaim unit handle. Finally, in response to the write command, the memory controller 520 writes the data to be written into the respective reclaim unit through the target reclaim unit handle corresponding to the write command.

That is, the heat value of the data to be written is less than or equal to the maximum heat value of the data written in all of the namespaces using the target reclaim unit handle, and the heat value of the data to be written is greater than or equal to the minimum heat value of the data written by all namespaces that use the target reclaim unit handle. This enables the external device to reasonably configure the reclaim unit handle used by a new namespace when creating the new namespace, thereby reducing the additional write amplification caused by using the same reclaim unit handle for data with large heat difference.

In some examples, the log page also includes usage information of the reclaim unit handle; the usage information is configured to indicate whether the reclaim unit handle is used; the memory controller 520 is also configured to: in response to a first query command, send the usage information of the reclaim unit handle in the log page; and in response to a second query command, send the second heat message of the reclaim unit handle in the log page.

In an example of the present disclosure, referring to FIG. 14, the log page may also record the usage information of each reclaim unit handle. For example, the usage information of the reclaim unit handle may include states such as “unused”, “used by the host”, “used by the memory controller”, etc., “unused” is configured to indicate that the corresponding reclaim unit handle is not used, “used by the host” is configured to indicate that the corresponding reclaim unit handle has been used by the host, and “used by memory controller” is configured to indicate that the corresponding reclaim unit handle has been used by the memory controller.

The external device may send a first query command to the memory controller 520, and the first query command is configured to query the usage information of one or more reclaim unit handles. The memory controller 520 may send the usage information of one or more reclaim unit handles in the log page to the external device in response to the first query command. The external device may also send a second query command to the memory controller 520, and the second query command is configured to query the second heat message of one or more reclaim unit handles. The memory controller 520 may also send the second heat message of one or more reclaim unit handles in the log page to the external device in response to the second query command.

In this way, before creating a new namespace, the external device can obtain the usage information and second heat messages of individual reclaim unit handles through the first query command and the second query command, thus may reasonably configure the reclaim unit handle used by a new namespace when creating the new namespace.

In some examples, one log page may record FDP configuration information corresponding to a plurality of reclaim unit handles (such as usage information, second heat message, etc.); in some other examples, one log page may only record the FDP configuration information corresponding to one reclaim unit handle, that is, the FDP configuration information corresponding to a plurality of reclaim unit handles is recorded by a plurality of log pages respectively.

In some examples, the memory controller 520 is further configured to: based on the reclaim unit handle corresponding to the created namespace, update usage information of the respective reclaim unit handle in the log page.

In an example of the present disclosure, the external device sends a namespace creation request command to the memory controller 520 and issues a placement handle list. The memory controller 520 creates a namespace in response to the namespace creation request command, and based on one or more reclaim unit handles in the placement handle list, updates the usage information of the corresponding reclaim unit handle in the log page. For example, the memory controller 520 can, based on one or more reclaim unit handles in the placement handle list issued by the host, update the usage information of the respective reclaim unit handle in the log page from “unused” to “used by the host”. It can be understood that if a certain reclaim unit handle has been used by other namespaces before, when the reclaim unit handle is used by the newly created namespace again, the usage information of the reclaim unit handle in the log page may not be updated.

In some examples, the creation of a namespace by an external device (such as a host) may include the following operations: First, before creating the namespace, the external device first queries the FDP configuration information of individual reclaim unit handles in the log page. For example, the host first queries the usage information of individual reclaim unit handles, and when the usage information of a reclaim unit handle is “used by the host”, the host further obtains the second heat message of the reclaim unit handle. Then, the external device selects a reclaim unit handle with appropriate heat, sends a namespace creation request command to the memory controller, and issues a respective placement handle list. The placement handle list is configured to specify the reclaim unit handle corresponding to each placement handle, and specifies the first heat message corresponding to each reclaim unit handle. Finally, the memory controller, in response to the namespace creation request command, creates a namespace and updates the usage information of the respective reclaim unit handle in the log page, and based on the first heat message in the placement handle list, updates the second heat message of the respective reclaim unit handle in the log page.

In some examples, the memory controller 520 is further configured to: generate configuration information based on the second heat messages of individual reclaim unit handles; where the configuration information comprises a mapping relationship between a plurality of reclaim unit handles and a plurality of namespaces, and a difference value between heat values of data written by any two namespaces that use a same reclaim unit handle in the configuration information is less than a second preset value; and send the configuration information in response to a third query command.

In an example of the present disclosure, the memory controller 520 may also generate configuration information based on the second heat messages of individual reclaim unit handles in the log page, where the configuration information may be a configuration suggestion for the reclaim unit handle used when creating a new namespace for reference by an external device. The configuration information may be stored in the memory controller 520 or the memory device 510 in the form of a log page. In some examples, the log page for storing the above configuration information and the log page for storing the second heat message may be different log pages.

For example, if an external device uses an unreasonable reclaim unit handle when creating a new namespace, such as the difference between the heat values of the data written through the same reclaim unit handle is big, in this case, the memory controller 520 can generate reasonable configuration information for the namespace and the reclaim unit handle based on the second heat messages of individual reclaim unit handles in the log page. The configuration information may include a mapping relationship between a plurality of recommended reclaim unit handles and a plurality of namespaces, where each namespace corresponds to at least one reclaim unit handle, and the difference value between the heat values of the data written by any two namespaces that use a same reclaim unit handle in the configuration information is less than a second preset value, here the second preset value can be adjusted according to the actual data heat degree classification requirements. It should be noted that the memory controller 520 can generate and modify the above configuration information in real time according to the second heat messages of individual reclaim unit handles, and is not limited to the case where the external device uses an unreasonable reclaim unit handle when creating a new namespace.

The external device (such as a host) may send a third query command which configured to obtain the above configuration information to the memory controller 520. In response to the third query command, the memory controller 520 sends the configuration information to the external device for reference when the external device creates a namespace. In this way, a reasonable feedback mechanism can be provided between the memory system and the external device to correct an unreasonable namespace and reclaim unit handle configuration.

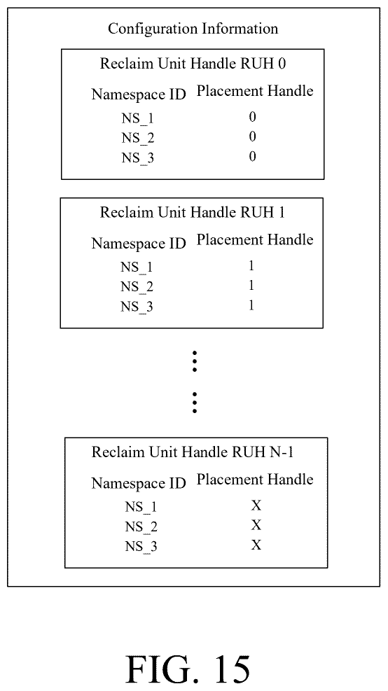

In some examples, the principles for the memory controller 520 to generate configuration information include but are not limited to: a) on the premise of all reclaim unit handles having been used up, placement handles with similar heat are mapped to the same reclaim unit handle; b) the amount of changes to the current handle list is minimized as much as possible. As shown in FIG. 15, an example format of a log page for recording the above configuration information is provided by the present disclosure. It should be noted that the log page for recording the above configuration information can also be in other formats, and the mapping relationship in FIG. 15 is only an example, and is not excessive limited herein. In some examples, the external device can also replace the reclaim unit handle through the RUH update command, thereby updating the placement handle list.

In some examples, the memory controller 520 may also proactively send the above configuration information to the external device, without having to send the above configuration information after receiving the third query command sent by the external device. In other words, the memory controller 520 can feedback the configuration suggestions of the namespace and the reclaim unit handle for reference by the external device in real time, rather than feedback only in a case where the external device uses an unreasonable reclaim unit handle when creating a namespace.

In some examples, the memory controller 520 is further configured to: in response to modifying the handle list, based on the modified first heat message, update the second heat message of the respective reclaim unit handle in the log page.

In an example the present disclosure, an external device (such as a host) can also proactively modify the placement handle list that has been issued, thereby updating the reclaim unit handle used by the namespace that has been created. For example, the external device can modify the reclaim unit handles corresponding to individual placement handles in the handle list, and modify the respective first heat message, and the memory controller 520 can, in response to the external device modifying the handle list, update the second heat message corresponding to the respective reclaim unit handle in the log page according to the first heat message corresponding to the modified one or more reclaim unit handles. In other words, when the external device modifies the handle list, it will issue the new first heat message corresponding to the modified reclaim unit handle, and the memory controller 520 will update the second heat message in the log page in time when the handle list is modified.

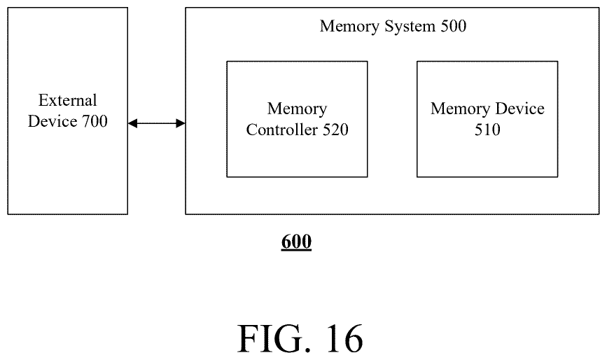

Based on the above memory system, as shown in FIG. 16, an example of the present disclosure further provides an electronic device 600, where the electronic device 600 includes a memory system 500 and an external device 700 coupled to the memory system 500. The memory system 500 includes: at least one memory device 510, the memory device 510 includes at least one reclaim group each reclaim group including at least one reclaim unit; a memory controller 520 coupled to the memory device 510. The external device 700 is configured to: send a plurality of first commands, where each first command is configured to indicate the memory system 500 to create a namespace, each namespace corresponds to at least one reclaim unit handle, a reclaim unit handle is configured to indicate one corresponding reclaim unit in each reclaim group; and generate a plurality of first heat messages, where each first heat message is configured to indicate heat of data written by one of the created namespaces using one reclaim unit handle. The memory system 500 is configured to: create a plurality of namespaces respectively in response to the plurality of first commands; and receive the plurality of first heat messages, and update a second heat message of a respective reclaim unit handle in a log page based on the first heat message; where the log page comprises second heat messages corresponding to the individual reclaim unit handles; and the second heat message is configured to indicate heat of data written by all namespaces that use a same reclaim unit handle.

In an example of the present disclosure, an electronic device 600 includes a memory system 500 and an external device 700. The external device 700 may be a host or any device using the memory system 500 that supports the FDP function. The memory device 510 may be identified as a plurality of reclaim groups each including one or more reclaim units. The memory controller 520 may receive a namespace creation request command sent by an external device (such as a host) to create a namespace. In some examples, each namespace creation request command may be configured to create a namespace; and in other examples, each namespace creation request command may be configured to create a plurality of namespaces.

The external device 700 may specify at least one reclaim unit handle for each created namespace. For example, when the host sends a namespace creation request command, it will issue a placement handle list corresponding to the namespace, which is referred to as a handle list. The placement handle list may include a plurality of placement handles and a plurality of reclaim unit handle IDs corresponding to a plurality of placement handles one by one. In this way, the external device 700 may send a write command including a namespace ID, a reclaim group ID, and placement handle information, so as to write the write data to the respective reclaim unit in the memory device 510. For example, if the namespace ID indicated by the write command is “NS_1”, the reclaim group ID is “RG_1”, and the placement handle is “1”, the write data will be written into the reclaim unit indicated by the reclaim unit handle RUH N-1 in the reclaim group RG_1 (as shown by the dotted circle in FIG. 13).

When sending a namespace creation request command, the external device 700 will also issue the first heat message corresponding to each reclaim unit handle used by the created namespace, and the first heat message is configured to indicate the heat of the data written by one created namespace using a reclaim unit handle. Referring to FIG. 13, each created namespace corresponds to one handle list which includes one or more reclaim unit handles used by the namespace and the first heat messages corresponding to the reclaim unit handles one by one. It should be noted that the external device 700 can also issue the first heat message to the memory system 500 in other ways, and is not limited to issuing the first heat message through a handle list.

A plurality of log pages may be stored in the memory system 500, and the log pages may be configured to record various configuration information related to the flexible data placement function. The log page may be stored in the memory device 510 or in the cache of the memory controller 520. For example, the log page may record second heat messages of individual reclaim unit handles, and each second heat message is configured to indicate the heat of the data that has been written by all namespaces that use one reclaim unit handle corresponding to the second heat message. It should be noted that any FDP configuration information (such as usage information, etc.) corresponding to individual reclaim unit handles may also be recorded in the log page. The second heat message may be the average heat value of the data that has been written by all namespaces that use the same reclaim unit handle, the maximum heat value and the minimum heat value of the data that has been written by all namespaces that use the same reclaim unit handle, or the median of the heat value of the data that has been written by all namespaces that use the same reclaim unit handle, etc., and the form of the second heat message is not overly restricted herein.

In this way, the log page records the second heat message corresponding to each reclaim unit handle, respectively. This enables the external device 700 to reasonably configure the reclaim unit handle used by a new namespace when creating the new namespace, for example, the heat of the data to be written corresponding to the new namespace is similar to or the same as the second heat message corresponding to the reclaim unit handle to be used by the new namespace, thereby reducing the additional write amplification caused by using the same reclaim unit handle for data with large differences in heat.

In some examples, the second heat message comprises an average heat value of data written by all namespaces that use the same reclaim unit handle. The external device 700 is further configured to: send a write command indicating a target reclaim unit handle corresponding to the data to be written, where a difference value between a heat value of the data to be written and an average heat value of data written by all namespaces that use the target reclaim unit handle is less than a first preset value. The memory system 500 is configured to: in response to the write command, write the data to be written into a reclaim unit indicated by the target reclaim unit handle corresponding to the write command.

In some examples, the second heat message comprises a maximum heat value and a minimum heat value of data written by all namespaces that use the same reclaim unit handle. The external device 700 is also configured to: send a write command indicating a target reclaim unit handle corresponding to the data to be written, where a heat value of the data to be written is less than or equal to a maximum heat value of data written by all namespaces that use the target reclaim unit handle, and the heat value of the data to be written is greater than or equal to a minimum heat value of the data written by all namespaces that use the target reclaim unit handle. The memory system 500 is configured to: in response to the write command, write the data to be written into a reclaim unit indicated by the target reclaim unit handle corresponding to the write command.

In some examples, the log page also includes usage information of the reclaim unit handle; the usage information is configured to indicate whether the reclaim unit handle is used by the external device. The external device 700 is also configured to: send a first query command which is configured to query the usage information of the reclaim unit handle in the log page; send a second query command when the usage information indicates that the reclaim unit handle is used by the external device 700, where the second query command is configured to query the second heat message of the reclaim unit handle in the log page; based on the second heat message, determine to at least one reclaim unit handle corresponding to the created namespace. The memory system 500 is also configured to: in response to the first query command sent by the external device 700, send the usage information of the reclaim unit handle in the log page to the external device 700; and in response to the second query command sent by the external device 700, send the second heat message of the reclaim unit handle in the log page to the external device 700.

In some examples, the external device 700 is further configured to: send a third query command to obtain configuration information from the memory system 500; where the configuration information comprises a mapping relationship between a plurality of reclaim unit handles and a plurality of namespaces, and a difference value between heat values of data written by any two namespaces that use a same reclaim unit handle in the configuration information is less than a second preset value. The memory system 500 is further configured to: generate the configuration information based on the second heat messages of individual reclaim unit handles; and send the configuration information to the external device in response to the third query command sent by the external device 700.

In some examples, the external device 700 is configured to: generate a handle list corresponding to the created namespace; where the handle list comprises a mapping relationship between a plurality of placement handles and a plurality of reclaim unit handles, and the first heat message corresponding to each of the reclaim unit handles; and the placement handle is configured to indicate a corresponding reclaim unit handle in a write command. The memory system 500 is configured to: receive the handle list generated by the external device.

In some examples, the external device 700 is also configured to: modify the mapping relationship between the placement handle and the reclaim unit handle in the handle list, and modify the first heat message corresponding to the reclaim unit handle. The memory system 500 is also configured to: in response to the external device modifying the handle list, update the second heat message of the respective reclaim unit handle in the log page based on the modified first heat message.

The details of the foregoing examples related to the electronic device 600 have been described in detail in the aforementioned examples related to the memory system 500, and will not be repeated here for brevity.

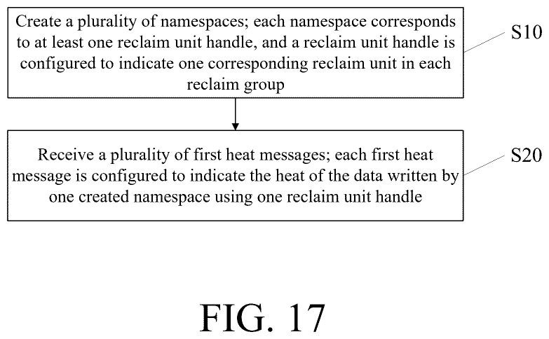

Based on the above memory system, an example of the present disclosure further provides an operation method of the memory system, where the memory system comprises at least one memory device, a memory device of the at least one memory device comprises at least one reclaim group, each of the at least one reclaim group comprises at least one reclaim unit; as shown in FIG. 17, the operation method includes the following operations:

Operation S10: create a plurality of namespaces; where each namespace corresponds to at least one reclaim unit handle, and a reclaim unit handle is configured to indicate one corresponding reclaim unit in each reclaim group;

Operation S20: receive a plurality of first heat messages; where each first heat message is configured to indicate the heat of data written by one created namespace using one reclaim unit handle.

It should be understood that the operations shown in FIG. 17 are not exclusive, and other operations may be performed before, after or between any operations in the shown operation; the operations shown in FIG. 17 may be adjusted in order according to actual needs.

In this way, the memory system can receive a plurality of first heat messages and record the heat of the data written by the created namespace using individual reclaim unit handles. For example, the memory system can separately record the heat message of all written data corresponding to each reclaim unit handle (that is, the data written by one or more created namespaces using the reclaim unit handle). This enables the external device to reasonably configure the reclaim unit handle used by a new namespace when creating the new namespace. For example, the heat of the data to be written corresponding to the new namespace is similar to or the same as the heat of the written data corresponding to the reclaim unit handle to be used by the new namespace, thereby reducing the additional write amplification caused by using the same reclaim unit handle for data with large heat difference.

In some examples, the operating method also includes: updating a second heat message of a respective reclaim unit handle in a log page based on the first heat message; where the log page comprises second heat messages corresponding to the individual reclaim unit handles; and the second heat message is configured to indicate heat of data written by all namespaces that use a same reclaim unit handle.

In some examples, the second heat message comprises an average heat value of data written by all namespaces that use the same reclaim unit handle. The operation method further includes: in response to a write command, writing data to be written into a reclaim unit indicated by a target reclaim unit handle corresponding to the write command; where a difference value between a heat value of the data to be written and an average heat value of data written by all namespaces that use the target reclaim unit handle is less than a first preset value.

In some examples, the second heat message comprises a maximum heat value and a minimum heat value of data written by all namespaces that use the same reclaim unit handle. The operation method also includes: in response to a write command, writing data to be written into a reclaim unit indicated by a target reclaim unit handle corresponding to the write command; where a heat value of the data to be written is less than or equal to a maximum heat value of data written by all namespaces that use the target reclaim unit handle, and the heat value of the data to be written is greater than or equal to a minimum heat value of the data written by all namespaces that use the target reclaim unit handle.

In some examples, the log page also includes usage information of the reclaim unit handle; the usage information is configured to indicate whether the reclaim unit handle is used; the operation method also includes: in response to a first query command, sending the usage information of the reclaim unit handle in the log page; in response to a second query command, sending the second heat message of the reclaim unit handle in the log page.

In some examples, the operation method further includes: based on the reclaim unit handle corresponding to the created namespace, updating usage information of the respective reclaim unit handle in the log page.

In some examples, the operation method also includes: generating configuration information based on the second heat messages of individual reclaim unit handles; where the configuration information comprises a mapping relationship between a plurality of reclaim unit handles and a plurality of namespaces, and a difference value between heat values of data written by any two namespaces that use a same reclaim unit handle in the configuration information is less than a second preset value; and sending the configuration information in response to a third query command.

In some examples, the receiving the plurality of first heat messages includes: receiving a handle list corresponding to the created namespace; where the handle list comprises a mapping relationship between a plurality of placement handles and a plurality of reclaim unit handles, and the first heat message corresponding to each of the reclaim unit handles; and the placement handle is configured to indicate a corresponding reclaim unit handle in a write command.

In some examples, the operation method further includes: in response to modifying the handle list, based on the modified first heat message, updating the second heat message of the respective reclaim unit handle in the log page.

The relevant details of the foregoing operation method of the memory system have been described in detail in the aforementioned example of the memory system 500, and will not be repeated here for brevity.

Based on the foregoing operation method of the memory system, an example of the present disclosure further provides a computer-readable storage medium having a computer program stored thereon. When the computer program is executed by a processor, the memory system operation method of any of the above-mentioned examples is executed.

Here, all or part of the processes in the operation method of the memory system in the foregoing example can be implemented by instructing the relevant hardware through a computer program, and the program can be stored in a computer-readable storage medium, and when the program is executed, it can include the processes of the examples of the foregoing methods. The storage medium can be a ferromagnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disk or a compact disc read-only memory (CD-ROM), etc.; and the storage medium can also include a combination of the above-mentioned types of memory.

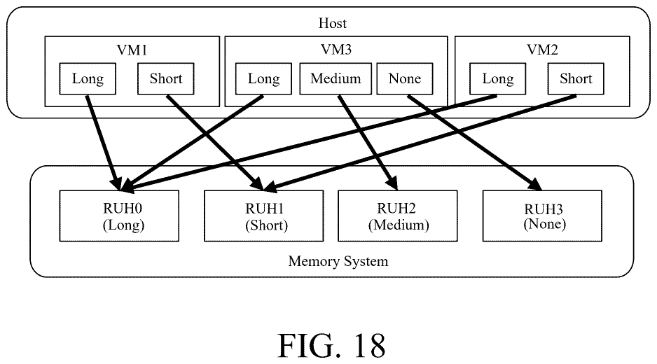

The memory system and its operation method, and the electronic device provided by the present disclosure can implement the configuration scheme of the reclaim unit handle as shown in FIG. 18. It can be seen that the write data with a heat of “Long” in the virtual machines VM1, VM2 and VM3 all used the reclaim unit handle RUH0, the write data with a heat of “Short” in the virtual machines VM1 and VM2 all used the reclaim unit handle RUH1, the write data with a heat of “Medium” in the virtual machine VM3 used the reclaim unit handle RUH2, and the write data with a heat of “None” in the virtual machine VM3 used the reclaim unit handle RUH3, in this way, the confusion of data with different heat degrees in the same reclaim unit handle can be reduced, and write amplification can be reduced.

In the memory system and its operation method and electronic device provided by the present disclosure, a log page can be configured to record the second heat messages of individual reclaim unit handles, and the second heat message is configured to indicate the heat of the data written by all namespaces using a reclaim unit handle; and the external device (such as a host) will send the first heat message when creating a namespace or modifying a placement handle list, so that the memory controller can update the second heat message based on the first heat message of each reclaim unit handle in time. The memory controller can also feedback reasonable configuration information of namespaces and reclaim unit handles based on the second heat messages of individual reclaim unit handles. In this way, the problem of unreasonable RUH use caused by tenants being unable to obtain the RUH configuration information of other tenants in a multi-tenant scenario can be reduced, and additional write amplification caused by unreasonable configuration can be avoided as much as possible.

The features disclosed in the several device examples provided in the present disclosure may be arbitrarily combined to obtain a new device example without conflict.

The methods disclosed in the several method examples provided in the present disclosure may be arbitrarily combined to obtain a new method example without conflict.

Examples of the present disclosure provide a memory system and operation method thereof and an electronic device.

In a first aspect, an example of the present disclosure provides a memory system, the memory system comprising:

at least one memory device, where a memory device of the at least one memory device comprises at least one reclaim group, each of the at least one reclaim group comprises at least one reclaim unit;

a memory controller coupled to the memory device and configured to:

create a plurality of namespaces; where each namespace corresponds to at least one reclaim unit handle, a reclaim unit handle is configured to indicate one corresponding reclaim unit in each reclaim group;

receive a plurality of first heat messages; each first heat message is configured to indicate heat of data written by one of the created namespaces using one reclaim unit handle.

In a second aspect, an example of the present disclosure provides an electronic device, the electronic device comprising a memory system and an external device coupled to the memory system; the memory system comprises:

at least one memory device, where a memory device of the at least one memory device comprises at least one reclaim group, each of the at least one reclaim group comprises at least one reclaim unit; and

a memory controller coupled to the memory device; and

the external device is configured to:

send a plurality of first commands; each first command is configured to indicate the memory system to create one namespace, each namespace corresponds to at least one reclaim unit handle, a reclaim unit handle is configured to indicate one corresponding reclaim unit in each reclaim group; and

generate a plurality of first heat messages; each first heat message is configured to indicate heat of data written by one of the created namespaces using one reclaim unit handle; and

the memory system is configured to:

in response to the plurality of first commands, creating a plurality of namespaces respectively; and

receive the plurality of first heat messages, and update a second heat message of a respective reclaim unit handle in a log page based on the first heat message; where the log page comprises second heat messages corresponding to the individual reclaim unit handles; and the second heat message is configured to indicate heat of data written by all namespaces that use a same reclaim unit handle.

In a third aspect, an example of the present disclosure provides an operation method of a memory system, where the memory system comprises at least one memory device, where a memory device of the at least one memory device comprises at least one reclaim group, each of the at least one reclaim group comprises at least one reclaim unit; and

the operation method comprises:

creating a plurality of namespaces; where each namespace corresponds to at least one reclaim unit handle, a reclaim unit handle is configured to indicate one corresponding reclaim unit in each reclaim group; and

receiving a plurality of first heat messages; each first heat message is configured to indicate heat of data written by one of the created namespaces using one reclaim unit handle.

In the examples of the present disclosure, the memory controller is configured to create a namespace and receive a plurality of first heat messages, each first heat message is configured to indicate heat of data written by one created namespace using one reclaim unit handle. In other words, the memory system can receive a plurality of first heat messages and record the heat of data written by the created namespace using the individual reclaim unit handles, so that the external device can reasonably configure reclaim unit handles used by a new namespace when creating the new namespace, reducing additional write amplification caused by using the same reclaim unit handle for data with large heat difference.

The above description only includes specific examples of the present disclosure, but the protection scope of the present disclosure is not limited thereto. Any person skilled in the art can easily think of changes or substitutions within the technical scope disclosed in the present disclosure, which should be covered in the protection scope of the present disclosure.

What is claimed is:

1. A memory system comprising:
a memory device, wherein the memory device comprises a reclaim group, the reclaim group comprises a reclaim unit; and
a memory controller coupled to the memory device and configured to:
create a plurality of namespaces, wherein a first namespace of the namespaces corresponds to at least one reclaim unit handle, the at least one reclaim unit handle is configured to indicate the reclaim unit in the reclaim group; and
receive a first heat message, wherein the first heat message is configured to indicate heat of first data written by the first namespace using one reclaim unit handle.

2. The memory system of claim 1, wherein:
the memory controller is configured to update a second heat message of a respective reclaim unit handle in a log page based on the first heat message;
the log page comprises a plurality of third heat messages corresponding to individual reclaim unit handles; and
the second heat message is configured to indicate heat of second data written by ones of the namespaces that use a same reclaim unit handle.

3. The memory system of claim 2, wherein the second heat message comprises an average heat value of the second data written by the ones of the namespaces that use the same reclaim unit handle, and the memory controller is configured to:
in response to a write command, write third data to be written into a second reclaim unit of the reclaim group based on the second reclaim unit being indicated by a target reclaim unit handle corresponding to the write command, wherein a difference value between a heat value of the third data to be written and an average heat value of fourth data written by ones of the namespaces that use the target reclaim unit handle is less than a first preset value.

4. The memory system of claim 2, wherein the second heat message comprises a maximum heat value and a minimum heat value of the second data written by the ones of the namespaces that use the same reclaim unit handle, the memory controller is configured to:
in response to a write command, write third data to be written into a second reclaim unit of the reclaim group based on the second reclaim unit being indicated by a target reclaim unit handle corresponding to the write command, wherein a heat value of the third data to be written is less than or equal to a maximum heat value of fourth data written by the ones of the namespaces that use the target reclaim unit handle, and the heat value of the third data to be written is greater than or equal to a minimum heat value of the fourth data written by the ones of the namespaces that use the target reclaim unit handle.

5. The memory system of claim 2, wherein:
the log page further comprises usage information of the reclaim unit handle in the log page;
the usage information is configured to indicate whether the reclaim unit handle in the log page is used; and
the memory controller is configured to:
in response to a first query command, send the usage information of the reclaim unit handle in the log page; and
in response to a second query command, send the second heat message of the reclaim unit handle in the log page.

6. The memory system of claim 5, wherein the memory controller is configured to:
based on the one reclaim unit handle corresponding to the first namespace, update the usage information of the reclaim unit handle in the log page.

7. The memory system of claim 2, wherein the memory controller is configured to, based on the plurality of third heat messages of the individual reclaim unit handles, generate configuration information, wherein:
the configuration information comprises a mapping relationship between a plurality of reclaim unit handles and the plurality of namespaces; and
a difference value between heat values of third data written by two of the namespaces that use a same reclaim unit handle in the configuration information is less than a second preset value; and
in response to a third query command, send the configuration information.

8. The memory system of claim 2, wherein the memory controller is configured to:
receive a handle list corresponding to the first namespace, wherein:
the handle list comprises a mapping relationship between a plurality of placement handles and a plurality of reclaim unit handles, the first heat message corresponding to the one reclaim unit handle, and one of the placement handles is configured to indicate a corresponding reclaim unit handle in a write command.

9. The memory system of claim 8, wherein the memory controller is configured to:
in response to modification of the handle list, update the second heat message of the respective reclaim unit handle in the log page based on a modified version of the first heat message.

10. An electronic device, comprising:
a memory system comprising:
a memory device, wherein the memory device comprises a reclaim group, the reclaim group comprises a reclaim unit; and
a memory controller coupled to the memory device; and
an external device coupled to the memory system and configured to:
send a plurality of first commands, wherein each of the first commands is configured to indicate the memory system to create a first namespace, the first namespace corresponds to at least one reclaim unit handle, the at least one reclaim unit handle is configured to indicate the reclaim unit in the reclaim group; and
generate a first heat message, wherein the first heat message is configured to indicate heat of first data written by the first namespace using one reclaim unit handle; and
the memory system is configured to:
in response to the plurality of first commands, create a plurality of namespaces respectively;
receive the first heat message; and
update a second heat message of a respective reclaim unit handle in a log page based on the first heat message, wherein:
the log page comprises a plurality of third heat messages corresponding to individual reclaim unit handles; and
the second heat message is configured to indicate heat of second data written by ones of the namespaces that use a same reclaim unit handle.

11. The electronic device of claim 10, wherein the second heat message comprises an average heat value of the second data written by the ones of the namespaces that use the same reclaim unit handle, and the external device is configured to:
send a write command, wherein:
the write command indicates a target reclaim unit handle corresponding to third data to be written; and
a difference value between a heat value of the third data to be written and the average heat value of fourth data written by the ones of the namespaces that use the target reclaim unit handle is less than a first preset value; and
the memory system is configured to:
in response to the write command, write the third data to be written into a second reclaim unit indicated by the target reclaim unit handle corresponding to the write command.

12. A method of a memory system, wherein the memory system comprises a memory device, the memory device comprises a reclaim group, the reclaim group comprises a reclaim unit, the method comprising:
creating a plurality of namespaces, wherein a first namespace of the namespaces corresponds to at least one reclaim unit handle, the at least one reclaim unit handle is configured to indicate the reclaim unit in the reclaim group; and
receiving a first heat message, wherein the first heat message is configured to indicate heat of first data written by the first namespace using one reclaim unit handle.

13. The method of claim 12, further comprising:
updating a second heat message of a respective reclaim unit handle in a log page based on the first heat message, wherein:
the log page comprises a plurality of third heat messages corresponding to individual reclaim unit handles; and
the second heat message is configured to indicate heat of second data written by ones of the namespaces that use a same reclaim unit handle.

14. The method of claim 13, wherein:
the second heat message comprises an average heat value of the second data written by the ones of the namespaces that use the same reclaim unit handle; and
the method further comprises:
in response to a write command, writing third data to be written into a second reclaim unit of the reclaim group based on the second reclaim unit being indicated by a target reclaim unit handle corresponding to the write command, wherein:
a difference value between a heat value of the third data to be written and an average heat value of fourth data written by the ones of the namespaces that use the target reclaim unit handle is less than a first preset value.

15. The method of claim 13, wherein:
the second heat message comprises a maximum heat value and a minimum heat value of the second data written by the ones of the namespaces that use the same reclaim unit handle; and
the method further comprises:
in response to a write command, writing third data to be written into a second reclaim unit of the reclaim group based on the second reclaim unit being indicated by a target reclaim unit handle corresponding to the write command, wherein:
a heat value of the third data to be written is less than or equal to a maximum heat value of fourth data written by ones of the namespaces that use the target reclaim unit handle; and
the heat value of the third data to be written is greater than or equal to a minimum heat value of the fourth data written by the ones of the namespaces that use the target reclaim unit handle.

16. The method of claim 13, wherein:
the log page further comprises usage information of the reclaim unit handle in the log page;
the usage information is configured to indicate whether the reclaim unit handle in the log page is used; and
the method further comprises:
in response to a first query command, sending the usage information of the reclaim unit handle in the log page; and
in response to a second query command, sending the second heat message of the reclaim unit handle in the log page.

17. The method of claim 16, further comprising:
based on the one reclaim unit handle corresponding to the first namespace, updating usage information of the reclaim unit handle in the log page.

18. The method of claim 13, further comprising:
generating configuration information based on the third heat messages of the individual reclaim unit handles, wherein:
the configuration information comprises a mapping relationship between a plurality of reclaim unit handles and the plurality of namespaces; and
a difference value between heat values of third data written by two of the namespaces that use a same reclaim unit handle in the configuration information is less than a second preset value; and
in response to a third query command, sending the configuration information.

19. The method of claim 13, wherein the receiving of the first heat message comprises:
receiving a handle list corresponding to the first namespace, wherein:
the handle list comprises a mapping relationship between a plurality of placement handles and a plurality of reclaim unit handles;
the first heat message corresponding to the one reclaim unit handle; and
one of the placement handles is configured to indicate a corresponding reclaim unit handle in a write command.

20. The method of claim 19, further comprising:
in response to a modification of the handle list, updating the second heat message of the reclaim unit handle in the log page based on a modified version of the first heat message.
